(19) United States
(12) Patent Application Publication
(10) Pub. No.: US 2026/0067141 A1
(43) Pub. Date: Mar. 5, 2026

(54) Signal Generation for Dual Functional Sensing and Communication

(71) Applicant: Samsung Electronics Company, Ltd., SUWON SI (KR)

(72) Inventors: Sanjeewa Herath, Stittsville (CA); Nuwan Ferdinand, Stittsville (CA)

(21) Appl. No.: 18/824,138

(22) Filed: Sep. 4, 2024

(51) Int. Cl. H04L 27/26; H04L 67/12; H04W 84/18

(52) U.S. Cl. CPC H04L 27/2602; H04L 67/12; H04W 84/18

(57) ABSTRACT

In one embodiment, a method includes accessing modulation symbols, determining a symbol pre-processing mechanism based on a first control input and a symbol post-processing mechanism based on a second control input, wherein the first and second control inputs are determined based on sensing-and-communication requirements that specify one or more of a sensing centric requirement, a communication centric requirement, or a requirement for dual function of sensing and communication, generating pre-processed symbols based on the symbol pre-processing mechanism and the modulation symbols, generating a post-processed symbols based on the symbol post-processing mechanism and the pre-processed symbols, wherein the symbol pre-processing mechanism and the symbol post-processing mechanism are configured to jointly modify a phase associated with the post-processed symbols linearly or quadratically with respect to the modulation symbols, and transmitting a signal generated based on the post-processed symbols.

### TECHNICAL FIELD

This disclosure generally relates to communication systems, and in particular relates to hardware and software for dual functioning of sensing and communication.

### BACKGROUND

Cellular systems such as 5G NR are primarily designed for communication purposes. The communication may occur from network side, gNB, or base station side to a device side (commonly known as downlink), from device side to a base station (commonly known as uplink) or from one device to another device (commonly known as side link). In these communication scenarios, a transmitter sends a signal over a wireless propagation channel to a receiver. This signal is optimized for communication purpose. Fr example, the signal is transmitted in such a way that the signal consumes as low as possible energy/power per transmitting bit, low peak-to-average power ratio (PAPR) for high transmitter power amplifier efficiency, etc. Current 5G NR uses orthogonal frequency division multiplexing (OFDM) based signal/waveform method for communication. There are two variations of OFDM used mainly, cyclic prefix based OFDM (CP-OFDM) and DFT spread CP-OFDM.

In the future cellular systems, it is envisioned that communication systems are dual functional, i.e., the same signal should be able to perform communication as well as sensing. There are 32 potential use cases listed in the 3GPP study for sensing. Sensing may be focused on sensing an object not directly connected to the network, i.e., device/object which is not a user device. Such sensing is similar to a radar system. This kind of sensing mainly involves estimating the position of an object such as vertical and horizontal distance/range (e.g., measure by meters) to the object from a given reference point in space, estimating the velocity of an object such as horizontal and vertical velocity measure in meters per second (m/s). Sensing may include metrics such as sensing to a given confidence level (%), range resolution, velocity resolution, service latency, refreshing rate, missed detection and false alarm. To achieve sensing targets, a receiver requires to estimate the parameters of the propagation channel using the received signal. Some of such channel parameters are Doppler frequency/spread, propagation delay, delay spread, multi-path vs line of sight propagation, power of multi-path, angle of arrival, angle of departure etc.

While OFDM based signals/waveforms such as CP-OFDM, DFT-s-OFDM is suitable for communication purposes, OFDM based signals are not well suited for sensing purposes listed above (or estimating the parameters mentioned above). Therefore, several studies propose modifications to the OFDM based waveforms or to use a completely different waveforms that generates radar like signals [5]. While sensing can be performed by a specifically designed radar like signals, the system to generate such radar signal is quite different from communication signal generation and requires different hardware components. As such, having separate hardware components to generate radar like signal can be costly, especially when the signal generation needs to be done at the device/UE side. On the other hand, OFDM based signals cannot perform sensing tasks accurately including accurate estimation of position/velocity including other sensing metrics such as range, velocity resolution etc. mentioned earlier.

Another aspect of sensing is the diverse sensing requirement of different applications/use-cases. In some use cases such as UAV intrusion detection, health monitoring, intrusion detection in smart home, etc., very high accurate sensing is required with high accurate position/velocity estimate with high resolution. Therefore, such application needs signal design that is sensing centric which means that primary objective of the signal design is sensing while communication is a secondary objective. In some other use cases such as weather monitoring, crowd monitoring, etc. may not require extremely high amount of sensing measurements so that sensing is a secondary objective while communication can be the primary objective, i.e., communication centric signal design. In some other use cases, the dual function of sensing and communication may be required, i.e., both sensing and communication objectives are equally important.

As a result, depending on the use case, the objectives of communication or sensing or both need to be met in different levels. Therefore, signals/waveforms should be able to support such diverse requirements. Moreover, the sensing/communication requirement may change over time (dynamic), e.g., based on the application the device is running. For example, when a device is used for navigation, sensing requirement may be more crucial whereas when the same device is streaming communication requirement may be relatively more important.

### BRIEF DESCRIPTION OF THE DRAWINGS

FIG. 1 illustrates an example transmit chain for generating a signal for dual functions of sensing and communication.

FIG. 2 illustrates an example transmit chain for generating AFDM signal for dual functions of sensing and communication.

FIG. 3 illustrates an example transmit chain for generating a chirp-based signal for dual functions of sensing and communication.

FIG. 4 illustrates an example transmit chain for generating OTFS signal for dual functions of sensing and communication.

FIGS. 5A-5C illustrate example scenarios of bi-static/monostatic sensing where the dual functional signal transmits from the network side.

FIGS. 6A-6B illustrate an example signaling diagram for bi-static/monostatic sensing where the dual functional signal transmits from the network side.

FIGS. 7A-7C illustrate example scenarios of bi-static/monostatic sensing where the dual functional signal transmits from a device.

FIGS. 8A-8B illustrate an example signaling diagram for bi-static/monostatic sensing where the dual functional signal transmits from device side.

FIG. 9 illustrates is a flow diagram of a method for generating a signal that can be used for both communication and sensing functions, in accordance with the presently disclosed embodiments.

FIG. 10 illustrates an example computer system that may be utilized for determining sensing and communication precoders, in accordance with the presently disclosed embodiments.

### DESCRIPTION OF EXAMPLE EMBODIMENTS

### Signal Generation for Dual Functional Radar/Sensing and Communication

In particular embodiments, a computing system may utilize a unified signal generation for dual functional of sensing and communication, i.e., common hardware for generating a signal that can be used for both communication and sensing functions. The unified signal generation may comprise the following steps. In particular embodiments, the sequence of output symbols from the modulation may be mapped to an OFDM resource grid. The mapped symbols may be passed to symbol pre-processing, followed by IFFT and symbol post-processing such that the phase of the data carrying symbols is modified quadratically (i.e., second order). Therefore, the symbol output from post-processing may occupy at least one of higher time or higher bandwidth than the original symbol. The computing system may use input-controlled symbol pre-processing and symbol post-processing for performing the signal processing to generate dual functional sensing and communication signals. In one embodiment, the mapped symbols phase may be quadratically varied to generate sensing centric signal. In another embodiment, the mapped symbols phase may be linearly varied to generate communication centric signals. Although this disclosure describes generating particular signals by particular systems in a particular manner, this disclosure contemplates generating any suitable signal by any suitable system in any suitable manner.

In particular embodiments, a first computing system may access a sequence of modulation symbols. The first computing system may then determine a symbol pre-processing mechanism based on a first control input and a symbol post-processing mechanism based on a second control input. The first and second control inputs may be determined based on one or more sensing-and-communication requirements. In particular embodiments, the one or more sensing-and-communication requirements may specify one or more of a sensing centric requirement, a communication centric requirement, or a requirement for dual function of sensing and communication. The first computing system may then generate, based on the symbol pre-processing mechanism and the sequence of modulation symbols, a sequence of pre-processed symbols. The first computing system may then generate, based on the symbol post-processing mechanism and the sequence of pre-processed symbols, a sequence of post-processed symbols. In particular embodiments, the symbol pre-processing mechanism and the symbol post-processing mechanism may be configured to jointly modify a phase associated with sequence of post-processed symbols linearly or quadratically with respect to the sequence of modulation symbols. The first computing system may further transmit a signal generated based on the sequence of post-processed symbols to a second computing system.

Certain technical challenges exist for generating a dual functional sensing-and-communication signal. One technical challenge may include dynamically adjusting the signal generation, i.e., sensing centric to communication centric and anywhere in between, by the same device. The solution presented by the embodiments disclosed herein to address this challenge may be using control inputs to adjust the unified hardware architecture to support all diverse and dynamic use cases and requirements, where the hardware components of the same device can be optimized for different scenarios. Another technical challenge may include backward compatibility. The solution presented by the embodiments disclosed herein to address this challenge may be a flexible and cost-effective hardware architecture for joint sensing and communication signal generation as the hardware architecture can generate OFDM based signals to support backward compatibility.

Certain embodiments disclosed herein may provide one or more technical advantages. A technical advantage of the embodiments may include cost effective and efficient use of hardware in generating a dual functional sensing and communication signal as the embodiments only need to adjust the symbol pre-processing and post-processing while keeping other components of the signal generation structure unchanged. Another technical advantage of the embodiments may include backward compatible as OFDM based signals can be generated from the same structure. Another technical advantage of the embodiments may include supporting a wide range of use cases that come with sensing centric signal design, communication centric signal design or dual function of sensing and communication centric signal design as the embodiments can dynamically adjust the generated signal for a use case. Another technical advantage of the embodiments may include adaptability to standards such as 3GPP and Wi-Fi as many components in the signal generation structure are already available in OFDM transmit chain, which can be re-used for sensing enabled signal generation. Certain embodiments disclosed herein may provide none, some, or all of the above technical advantages. One or more other technical advantages may be readily apparent to one skilled in the art in view of the figures, descriptions, and claims of the present disclosure.

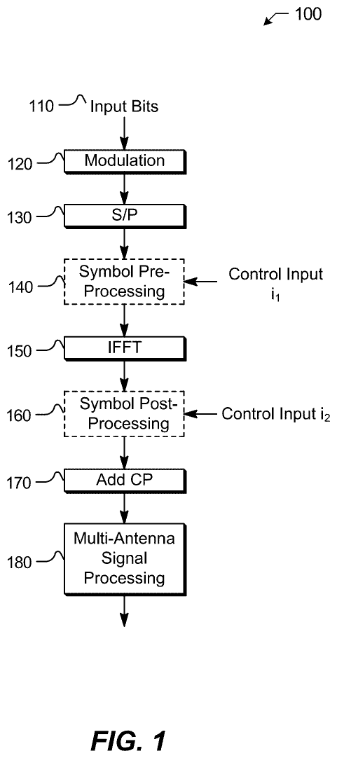

FIG. 1 illustrates an example transmit chain 100 for generating a signal for dual functions of sensing and communication. The dual functional sensing and communication signal is generated using the transmit chain by controlling the one or more control inputs values of i₁, i₂. In particular embodiments, the input bits 110 may be an output of a forward error correction (FEC) encoder. The input to the FEC encoder may be a stream of information bits d∈{0,1}^{p} of length p and the FEC encoder may output a stream of bits (commonly referred as codeword(s)) c∈{0,1}ⁿ of bit-length n where n≥p. When n=p, there may be no redundancy (bits) being added by the FEC encoder, which is commonly known as uncoded system. When n>p, the redundancy (bits) may be added by the FEC encoder, which is commonly known as coded system. The ratio of p/n is commonly referred as code rate (r). Therefore, for a coded system/transmission, r<1; for uncoded system, r=1. The additional bits (i.e., redundancy bits) added by the FEC encoder may help the FEC decoder correctly estimate the information bits transmitted by the transmitter despite having various impairments including the propagation channel impairments and hardware-based impairments. The ability of correcting the errors induced by the channel impairments by the FEC encoder/decoder may be utilized by communication systems and such gains achieved by FEC is commonly referred as coding gain. It should also be noted that the FEC encoder may perform channel coding and may also perform cyclic redundancy check (CRC) attachment, code block segmentation, per code block CRC attachment, rate matching, code block concatenation, etc. The FEC codes such as LDPC, Polar, Turbo, Convolution codes may be a few candidate example encoding methods that can be applied in the FEC encoder.

The output of the FEC encoder can be further processed through bit-level processing such as bit scrambling, bit interleaving, etc., which can be controlled by the inputs (not explicitly shown in FIG. 1).

In particular embodiments, the coded bits may be mapped to constellation points. The process of mapping coded bits to constellation points is commonly known as modulation 120. The modulation output may be represented by a constellation diagram. A constellation diagram is a representation of a signal modulated by a digital modulation scheme where constellation points represent the possible symbols to be transmitted based on the input bits. In current wireless standards such as 3GPP 5G NR, legacy modulation schemes such as BPSK, π/2-BPSK, QPSK, 16-QAM, 256-QAM, 1024-QAM or in general m-QAM may be used for modulation 120. The stream of input bits to the modulation 120 may be outputted as a stream of modulation symbols d(0), d(1), d(2), . . . . The choice of modulation being used in the transmit chain 100 can also be controlled by the control inputs (not explicitly shown in FIG. 1).

In particular embodiments, the modulation output may be processed by a serial-to-parallel (S/P) block 130. The S/P block 130 may map OFDM symbols to two-dimensional grid of N rows and M columns. In other words, the computing system may generate, based on the sequence of modulation symbols, a matrix of symbols. Table 1 shows an example two-dimensional grid. In particular embodiments, the column size may be 1, i.e., M=1.

TABLE 1
A two-dimensional grid mapped from the OFDM symbols.

| | | | |
|---|---|---|---|
| d(0) | d(N) | . . . | |
| d(1) | d(N + 1) | | |
| . | . | . | . |
| . | . | . | . |
| . | . | . | . |
| d(N − 1) | d(2N − 1) | . . . | d(MN − 1) |

In alternative embodiments, mapped symbols can be smaller than N where only a portion or a sub-set of two-dimensional grid is mapped with modulation symbols.

The control input i₁ and i₂ may comprise logic specifying what operations to perform in the symbol pre-processing block 140 and symbol post-processing block 160. Using control inputs to adjust the unified hardware architecture to support all diverse and dynamic use cases and requirements may be an effective solution for addressing the technical challenge of dynamically adjusting the signal generation, i.e., sensing centric to communication centric and anywhere in between, by the same device as the hardware components of the same device can be optimized for different scenarios. When the control input i₁ and i₂ are configured such that a symbol pre-processing block 140 and a symbol post-processing block 160 do not perform any specific operations on the input bits 110 to each block (i.e., bypassing the input to the output), the transmit chain 100 shown in FIG. 1 may produce legacy OFDM symbols in conjunction with the operations performed by the IFFT block 150, adding CP block 170 and legacy multi-antenna signal processing 180. A flexible and cost-effective hardware architecture for joint sensing and communication signal generation may be an effective solution for addressing the technical challenge of backward compatibility as the hardware architecture can generate OFDM based signals to support backward compatibility.

The cyclic prefix (CP) may be added by placing last few samples of the generated symbol before the start in addition to retaining them at the end. The CP symbols may be placed in such a way that they act as guard interval between any two different generated symbols. Alternative methods may be also feasible. For example, instead of repeating the last few samples at the beginning, zeros may be added (samples of zero power, i.e., guard time) or no CP may be added. The choice of adding CP block 170 may also be controlled by a control input (not shown in FIG. 1).

The output from the CP 170 may be provided to the multi-antenna signal processing block 180 for processing the signal for multi-antenna signal processing.

In particular embodiments, the signal generated as the output of the symbol post-processing block 160 can be expressed as:

$$\begin{matrix}s ( mN + k ) = \frac{1}{\sqrt{N}} {\sum }_{n = 0}^{N - 1} d ( m N + n ) exp ( \frac{j 2 π k n}{N} ) , \\ m ∈ \{ 0 , 1 , … , M - 1 \} , k ∈ \{ 0 , 1 , … , N - 1 \}\end{matrix} \qquad ( 1 )$$

where M is the number of symbols and N is the number of subcarriers. Note that the processing of each column of the two-dimensional grid can be performed column by column, i.e., for each m where m∈{0,1, . . . , M−1}.

It should be noted that Equation (1) shows the discrete signal generated by the processing at digital baseband. The corresponding passband time continuous signal for m-th symbol sₘ(t) can be expressed as:

$$\begin{matrix}{s}_{m} ( t ) = {\sum }_{n = 0}^{N - 1} d ( n ) exp ( \frac{j 2 π n t}{N} ) , & 0 \leq t < {T}_{s} , & m ∈ \{ 0 , 1 , … , M - 1 \}\end{matrix} \qquad ( 2 )$$

where Tₛ is the symbol duration. Equation (2) can also be expressed in terms of subcarrier spacing ΔF where

$$Δ F = \frac{1}{N} .$$

It should be noted that there may exist different ways to obtain/synthesize the time continuous signal from its discrete counterpart.

It is observed from Equation (1) and Equation (2) that the phase of the constellation symbol is linearly modified to obtain the output symbol (i.e., OFDM transmission). As described earlier, the resulting symbol/signal may be a suitable choice for communication purposes and may be widely adopted in cellular systems such as 5G NR, Wi-Fi, etc. However, the resulting symbol/signal may be still used for sensing purposes. The embodiments disclosed herein may have a technical advantage of backward compatible as OFDM based signals can be generated from the same structure. In addition, the embodiments disclosed herein may have another technical advantage of adaptability to standards such as 3GPP and Wi-Fi as many components in the signal generation structure are already available in OFDM transmit chain, which can be re-used for sensing enabled signal generation.

In particular embodiments, the computing system may generate signals for dual function of sensing and communication. In one embodiment, the computing system may generate a signal based on affine frequency division multiplexing (AFDM). In this embodiment, the one or more sensing-and-communication requirements may specify a sensing centric requirement. The first control input may configure the symbol pre-processing mechanism to perform a first operation and the second control input may configure the symbol post-processing mechanism to perform a second operation. The first and second operations may result in the signal being based on affine frequency division multiplexing. In addition, the phase associated with the sequence of post-processed symbols may be modified quadratically with respect to the sequence of modulation symbols.

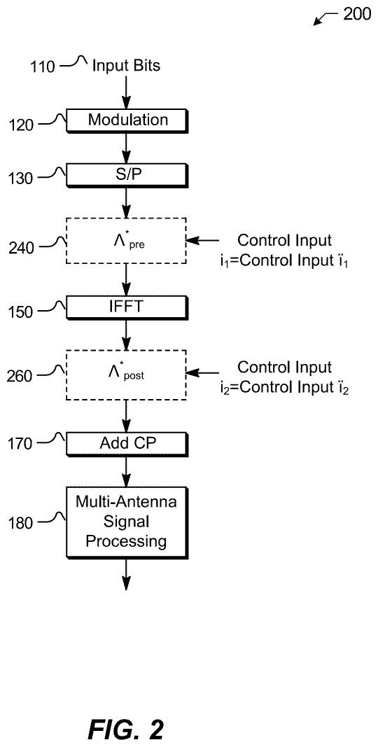

FIG. 2 illustrates an example transmit chain 200 for generating AFDM signal for dual functions of sensing and communication. In the following configuration, a joint sensing and communication signal can be generated. The symbol pre-processing block 240 may be configured to perform the following operation through control input i₁:

$${Λ}_{p r e} = diag ( exp ( - j 2 π {c}_{2} {n}^{2} ) , n = 0 , 1 , … , N - 1 ) \qquad ( 3 )$$

with any real constant c₁.

The symbol post-processing block 260 may be configured to perform following operation through control input i₂:

$${Λ}_{post} = diag ( exp ( - j 2 π {c}_{1} {n}^{2} ) , n = 0 , 1 , … , N - 1 ) \qquad ( 4 )$$

with any real constant c₂.

The parameters c₁ and c₂ can be chosen differently to optimize for different scenarios.

The signal generated as the output of symbol post-processing block 260 can be expressed as:

$$s ( mN + k ) = \frac{1}{\sqrt{N}} exp ( j 2 π {c}_{1} {k}^{2} ) {\sum }_{n = 0}^{N - 1} d ( mN + n ) exp ( j 2 π ( \frac{k n}{N} + {c}_{2} {n}^{2} ) ) , \qquad ( 5 )$$

$$m ∈ \{ 0 , 1 , … , M - 1 \} , k ∈ \{ 0 , 1 , … , N - 1 \}$$

The processing of each column of the two-dimensional grid can be performed column by column, i.e., for each m where m∈{0,1, . . . , M−1}. From Equation (5) when c₁=0 and c₂=0, one may obtain the OFDM signal given in Equation (1). It means that the particular values of c₁=0 and c₂=0 using a transmit chain similar to FIG. 2 can generate the OFDM signal as well. This may be of particular interest as a single transmit chain can generate both OFDM (optimized and used for communication purposes in current 5G NR/Wi-Fi/TV broadcast systems) and an AFDM signal that is suitable for sensing purposes (as described later in this disclosure).

Equation (5) can be written as:

$$s ( mN + k ) = \frac{1}{\sqrt{N}} {\sum }_{n = 0}^{N - 1} d ( mN + n ) exp ( j 2 π ( \frac{kn}{N} + {c}_{2} {n}^{2} + {c}_{1} {k}^{2} ) ) , \qquad ( 6 )$$

$$m ∈ \{ 0 , 1 , … , M - 1 \} , k ∈ \{ 0 , 1 , … , N - 1 \}$$

Equation (5) shows the discrete signal generated based on the processing at digital baseband. The corresponding passband time continuous signal for m-th symbol sₘ(t) may be expressed as:

$${s}_{m} ( t ) = {\sum }_{n = 0}^{N - 1} d ( n ) exp ( j 2 π ( \frac{nt}{N} + {c}_{2} {n}^{2} + {c}_{1} {t}^{2} ) ) , \qquad ( 7 )$$

$$0 \leq t < {T}_{s} , m ∈ \{ 0 , 1 , … , M - 1 \}$$

where Tₛ is the symbol duration. Equation (2.2) can also be expressed in terms of subcarrier spacing ΔF where

$$Δ F = \frac{1}{N} .$$

It is observed from equation (2.0) and (2.2) that the phase of the constellation symbols is quadratically (second order quadratic polynomial) adjusted by the combined effects of the symbol pre-processing 240 and post-processing 260 blocks to obtain the output symbol. The generated sensing centric signals (i.e., quadratic phase varying symbols) may occupy at least one of higher time or higher bandwidth than communication centric signals (i.e., linear phase varying symbols such as OFDM).

In another embodiment, the computing system may generate a signal based on orthogonal chirp division multiplexing. In this embodiment, the one or more sensing-and-communication requirements may specify a communication centric requirement. The first control input may configure the symbol pre-processing mechanism to perform a first operation and the second control input may configure the symbol post-processing mechanism to perform a second operation. The first and second operations may result in the signal being based on orthogonal chirp division multiplexing. In addition, the phase associated with the sequence of post-processed symbols may be modified linearly with respect to the sequence of modulation symbols.

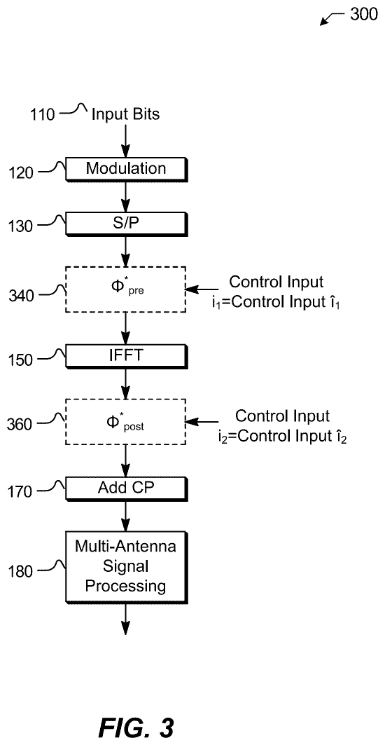

FIG. 3 illustrates an example transmit chain 300 for generating a chirp-based signal for dual functions of sensing and communication. In the following configuration, a joint sensing and communication signal can be generated. The symbol pre-processing 340 may be configured to perform the following operation through the control input i₁:

$${Φ}_{pre} = diag ( {q}_{0} , {q}_{1} , … , {q}_{N - 1} ) \qquad ( 8 )$$

$$where {q}_{n} = \{ \begin{matrix}exp ( \frac{j π}{N} {n}^{2} ) , & N ≡ 0 ( mod 2 ) \\ exp ( \frac{j π}{N} ( {n}^{2} - n ) ) , & N ≡ 1 ( mod 2 )\end{matrix}$$

$$and n = 0 , … , N - 1.$$

The symbol post-processing block 460 may be configured to perform the following operation through control input i₂:

$${Φ}_{post} = diag ( {q}_{0} , {q}_{1} , … , {q}_{N - 1} ) \qquad ( 9 )$$

$$where {q}_{n} = exp ( - \frac{j π}{4} ) \times \{ \begin{matrix}exp ( \frac{j π}{N} {n}^{2} ) , & N ≡ 0 ( mod 2 ) \\ exp ( \frac{j π}{4 N} ) exp ( \frac{j π}{N} ( {n}^{2} - n ) ) , & N ≡ 1 ( mod 2 )\end{matrix}$$

$$and n = 0 , … , N - 1.$$

The signal generated as the output of symbol post-processing block can be expressed as:

$$s ( mN + k ) = \{ \begin{matrix}\frac{1}{\sqrt{N}} exp ( \frac{j π}{4} ) {\sum }_{n = 0}^{N - 1} d ( mN + n ) exp ( - j \frac{π}{N} {( k - n )}^{2} ) , & N ≡ 0 ( mod 2 ) \\ \frac{1}{\sqrt{N}} exp ( \frac{j π}{4} ) {\sum }_{n = 0}^{N - 1} d ( mN + n ) exp ( - j \frac{π}{N} {( k - n + \frac{1}{2} )}^{2} ) , & N ≡ 1 ( mod 2 )\end{matrix} , \qquad ( 10 )$$

$$k ∈ \{ 0 , 1 , … , N - 1 \}$$

The processing of each column of the two-dimensional grid may be performed column by column, i.e., for each m where m∈{0,1, . . . , M−1}.

Equation (10) shows the discrete signal generated based on the processing at digital baseband. The corresponding passband time continuous signal for m-th symbol sₘ(t) for N≡0(mod 2) may be expressed as:

$${s}_{m} ( t ) = {\sum }_{n = 0}^{N - 1} d ( n ) exp ( \frac{j π}{4} ) exp ( - \frac{j π}{N} {( t - n )}^{2} ) , \qquad ( 11 )$$

$$0 \leq t < {T}_{s} , m ∈ \{ 0 , 1 , … , M - 1 \}$$

Similarly, time continuous signal for m-th symbol sₘ(t) for N≡0(mod 2) may be expressed as:

$${s}_{m} ( t ) = \frac{1}{\sqrt{N}} exp ( \frac{j π}{4} ) {\sum }_{n = 0}^{N - 1} d ( n ) exp ( - j \frac{π}{N} {( t - n + \frac{1}{2} )}^{2} ) , 0 \leq t < {T}_{s} , \qquad ( 12 )$$

$$m ∈ \{ 0 , 1 , … , M - 1 \}$$

where Tₛ is the symbol duration. Equation (11) and Equation (12) can also be expressed in terms of subcarrier spacing ΔF where

$$Δ F = \frac{1}{N} .$$

It may be observed from Equations (10)-(12) that the phase of the constellation symbol is quadratically (second order quadratic polynomial) adjusted by the combined effects of the symbol pre-processing 340 and post-processing 360 blocks to obtain the output symbol. The generated sensing centric signals (i.e., quadratic phase varying symbols) may occupy at least one of higher time or higher bandwidth than communication centric signals (i.e., linear phase varying symbols such as OFDM).

From Equation (5), it may be observed that when c₁=−½N and c₂=−½N, the following signal can be obtained:

$$s ( mN + k ) = \frac{1}{\sqrt{N}} exp ( - \frac{j π {k}^{2}}{N} ) {\sum }_{n = 0}^{N - 1} d ( m N + n ) exp ( j 2 π ( \frac{kn}{N} - \frac{{n}^{2}}{2 N} ) ) , \qquad ( 13 )$$

$$k ∈ \{ 0 , 1 , … , N - 1 \}$$

$$s ( mN + k ) = \frac{1}{\sqrt{N}} {\sum }_{n = 0}^{N - 1} d ( mN + n ) exp ( - \frac{j π}{N} ( - 2 kn + {n}^{2} + {k}^{2} ) ) ,$$

$$s ( mN + k ) = \frac{1}{\sqrt{N}} {\sum }_{n = 0}^{N - 1} d ( mN + n ) exp ( - \frac{j π}{N} {( k - n )}^{2} ) .$$

Note that the signal in Equation (13) may be similar to the signal generated based on Equation (10) (except exp

$$( \frac{j π}{4} )$$

term). See for example s(mN+k). Note that the term exp

$$( \frac{j π}{4} )$$

may be treated as a fixed phase change of the modulation signal.

In yet another embodiment, the computing system may generate a signal based on orthogonal time frequency space (OTFS) modulation. In this embodiment, the one or more sensing-and-communication requirements may specify a requirement for dual function of sensing and communication. The first control input may configure the symbol pre-processing mechanism to perform a first operation and the second control input may configure the symbol post-processing mechanism to perform a second operation. The first and second operations may result in the signal being based on orthogonal time frequency space modulation.

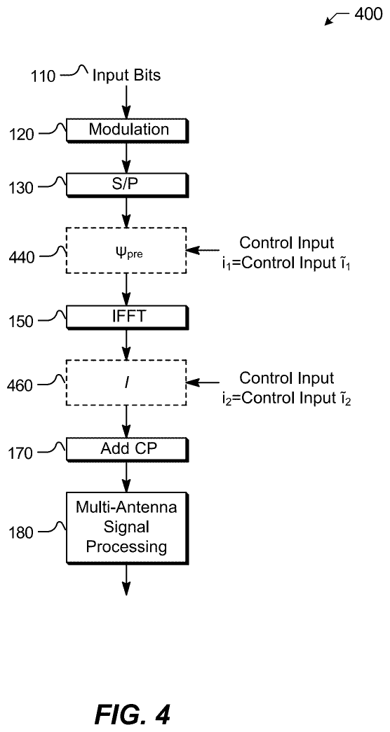

FIG. 4 illustrates an example transmit chain 400 for generating OTFS signal for dual functions of sensing and communication. In the following configuration, a joint sensing and communication signal can be generated. Differently from the other waveforms described earlier, the signal pre-processing block 440 in transmit chain 400 may comprise three steps. First, the signal pre-processing 440 may form two-dimensional grid of MN symbols as shown below in Table 2.

TABLE 2
A two-dimensional grid of MN symbols.

| | | | |
|---|---|---|---|
| d(0) | d(N) | . . . | |
| d(1) | d(N + 1) | | |
| . | . | . | . |
| . | . | . | . |
| . | . | . | . |
| d(N − 1) | d(2N − 1) | . . . | d(MN − 1) |

In alternative embodiments, this two-dimensional grid may be directly input to the symbol pre-processing block 440.

As the next step, the symbol pre-processing block 440 may be configured to perform the following operation through control input i₁:

$${Ψ}_{pre} [ n , m ] = W [ n , m ] {SFFT}^{- 1} ( d [ k , l ] ) \qquad ( 14 )$$

$$where {SFFT}^{- 1} ( d [ k , l ] ) = \frac{1}{MN} {\sum }_{l , k} d [ k , l ] exp ( j 2 π ( \frac{nk}{N} - \frac{ml}{M} ) ) , d [ k , l ]$$

is the modulation symbols arranged on the two-dimensional grid and k=0, . . . , N−1, l=0, . . . , M−1, and W[n, m] is a square summable function (the transmit windowing function).

As the last step, the symbol pre-processing block 440 may sequentially output columns of Ψₚᵣₑ[n, m], which is of size N×1, to the IFFT block 150.

The symbol post-processing block 460 may be configured such that the input is passed to the output (short-circuit/bypass).

For the transmitter and the receiver to operate, both the transmitter and the receiver should know the chosen waveform and its related parameters, which can be captured in the following way. First for all waveforms, the control inputs i₁ and i₂ for the symbol pre-processing and symbol post-processing operations may be specified at both the transmitter and the receiver. Before the signal transmission, both the transmitter and the receiver should know the chosen waveform, which can be performed through signaling. In particular embodiments, the first computing system may signal, by the first computing system, the first and second control inputs to the second computing system. As an example and not by way of limitation, the transmitter can signal the receiver to indicate the chosen waveform. Alternatively, the receiver can indicate to the transmitter the chosen waveform via signaling. Further, additional parameters related to specific waveform may be signaled between the transmitter and the receiver. Example parameters may include c₁ and c₂ of the AFDM waveform. Once both the transmitter and the receiver agree on the waveform and its parameters, the transmitter can use the specified waveform generation procedure controlled by i₁ and i₂ to generate the waveform/signal. As the receiver is aware of the chosen waveform, it can use the details of the waveform for demodulation process and sensing process.

As described with references to FIGS. 1-4, a technical advantage of the embodiments may include cost effective and efficient use of hardware in generating a dual functional sensing and communication signal as the embodiments only need to adjust the symbol pre-processing and post-processing while keeping other components of the signal generation structure unchanged. Another technical advantage of the embodiments may include supporting a wide range of use cases that come with sensing centric signal design, communication centric signal design or dual function of sensing and communication centric signal design as the embodiments can dynamically adjust the generated signal for a use case.

As described in detail in the following disclosure, the transmitter (i.e., dual functional signal generation/transmission node), the receiver for data demodulation, and the receiver for sensing can be different nodes in a given system. The signaling and parameter value agreements may vary across such possible configurations. Selected/representative configurations and signaling diagrams are shown below to demonstrate the scope of particular embodiments.

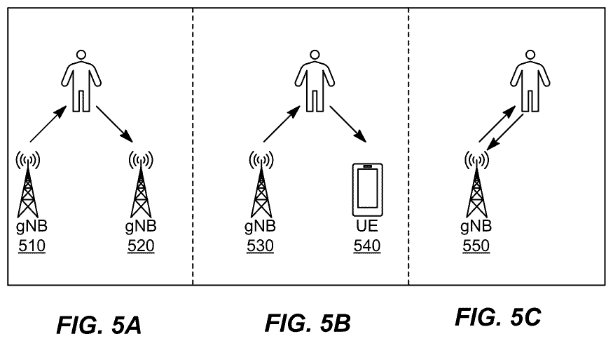

FIGS. 5A-5C illustrate example scenarios of bi-static/monostatic sensing where the dual functional signal transmits from the network side. In the setup of bi-static/monostatic sensing where the common signal transmission from a network side node, one or more of network side node(s) such as base station or relay may generate the dual functional communication-and-sensing signal and transmit. The same network-side node (i.e., the same transmitting node) and one or more base station(s)/relay(s) or device(s) may perform the sensing. These scenarios are shown in FIG. 5. FIG. 5A and FIG. 5B show the bistatic sensing scenario where the dual function of communication-and-sensing signal is received by a network-side node such as base station/relay (gNB 520) and a device/user equipment (UE 540), respectively. The received signal may be used/intended to be used for sensing functions by the receiver. The signal reception by the receivers that intends to decode data (receiver for communication function) can be done by the same node performing sensing or by other nodes in the system such as one or more of base station(s)/relay(s) and/or device(s). FIG. 5C shows the monostatic sensing scenario where the same network-side node such as base station/relay (gNB 550) performs the transmission and sensing functions. These scenarios can be for downlink transmission (network-side node transmission to a device side), wireless backhaul links, or relay link.

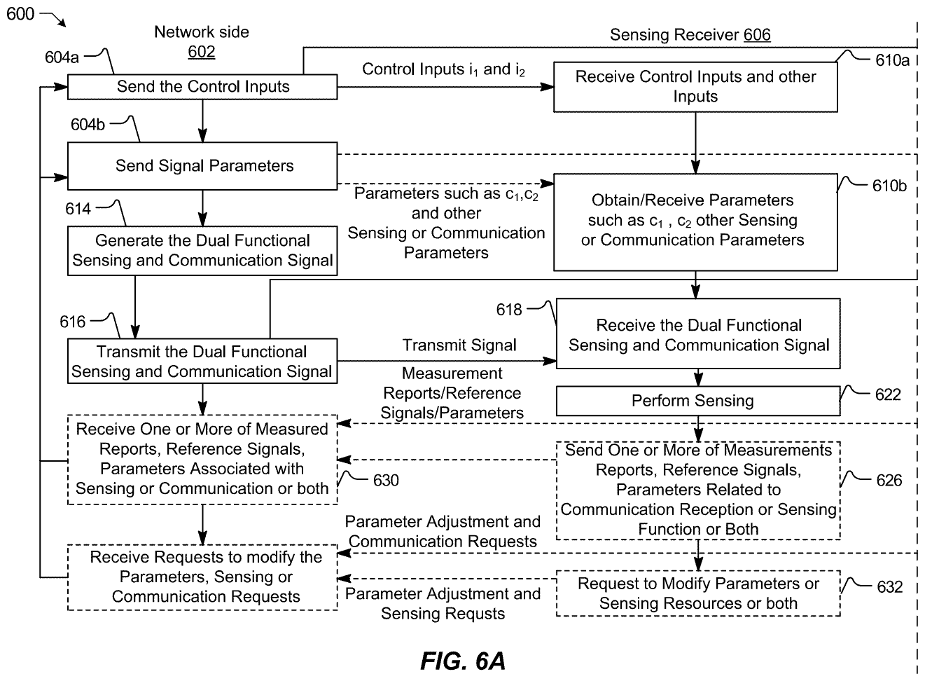

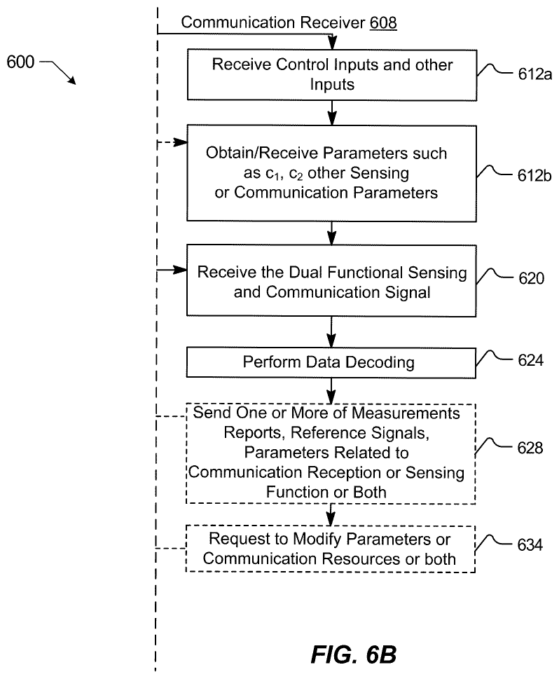

FIGS. 6A-6B illustrate an example signaling diagram 600 for bi-static/monostatic sensing where the dual functional signal transmits from the network side. As described earlier, the controlled inputs i₁ and i₂ and parameters such as c₁ and c₂ can be chosen/configured/selected by the transmitter side (one or more network-side nodes 602). At step 604, the selected control input values and parameters may be sent to the receiver(s) 606 performing sensing function and to the receiver(s) 608 performing decoding of the communication signal (to recover information bits).

At step 610, a sensing functional node 606 may receive one or more of the controlled inputs and parameters over a signaling channel such as RRC, MAC-CE, DCI, etc. Alternatively, one or more of the sensing functional nodes 606 may obtain the controlled inputs and parameters by blindly decoding them at the receiver sides. Alternatively, one or more of the sensing functional nodes 606 may obtain the controlled inputs and parameters by implicit manner. As an example and not by way of limitation, given a certain mode of operation, other communication/sensing requirement/configuration etc. can help obtain the parameter values and control inputs. At step 612, the communication receiver 608 may obtain the controlled inputs and parameters. Sensing receiver 606 and communication receiver 608 may receive the same control inputs and parameters or different control inputs and parameters. As an example and not by way of limitation, communication receiver 608 may require all control inputs and parameters while particular sensing function may only require a sub-set of control inputs or parameters.

Once the transmitter and receiver sides are aware of the control inputs and parameters, the network side 602 may generate the dual functional sensing and communication signal based on the agreed parameters at step 614. At step 616, the network side 602 may transmit the signal. The signal may be received by the sensing receiver 606 at step 618 as well as the communication receiver 608 at step 620. The sensing receiver 606 and communication receiver 608 may also be within the same node, for example, as two separate modules. At step 622, the sensing receiver 606 may perform the sensing from the received signal. Sensing may include estimating one or more of the parameters from the propagated signal such as Doppler shift, angle of arrival, angle of departure, propagation delay, pathloss, power delay profile, number of paths, line of sight, non-line of sight, etc. At step 624, the communication receiver 608 may perform the data decoding from the received signal to recover transmitted information bits.

After receiving the dual functional sensing-and-communication signal, one or both of the receivers or modules may perform certain measurements (optional). At step 626, such measurements may be reported back to the network side 602 by the sensing receiver. At step 628, such measurements may be reported back to the network side 602 by the communication receiver 608. Such measurement may also trigger other actions such as transmitting configured reference signal back to the network side 602. These measurements may be related to sensing function or communication function or both. One such sensing measurement may be the radar distortion. One such measurement for communication may be the received signal-to-interference-plus-noise (SINR) ratio. At step 630, the network side 602 may receive one or more of the measured reports, reference signals, parameters associated with sensing or communication or both.

At step 632 and step 634, sensing receiver 606 or communication receiver 608 or both may also request the network side 602 to adjust/modify/update the signal parameters or report the most suitable control inputs/parameters. Sensing receiver 606 or communication receiver 608 or both may also request further transmissions (dual functional or single functional) to perform further communication or sensing or both. As an example and not by way of limitation, after data decoding failure, communication receiver 608 may request a re-transmission (e.g., hybrid ARQ). Such request may be sent to the network side 602 along with new parameters or configurations or control inputs or otherwise. In another example, after sensing failure (i.e., sensing does not meet the target KPI such as accuracy, resolution, range estimate or other parameter estimation performance target), the sensing receiver 606 may request a re-transmission to perform further sensing. Such request may be sent to the network side 602 along with new parameters or configurations or control inputs or otherwise. At step 636, the network side 602 may receive the requests to modify the parameters, sensing or communication requests.

After receiving the measurement reports, reference signals, parameter updates, communication/sensing requests from sensing receiver 606 or communication receiver 608 or both, the network side 602 may determine the changes or modifications to the existing transmission parameters and control inputs.

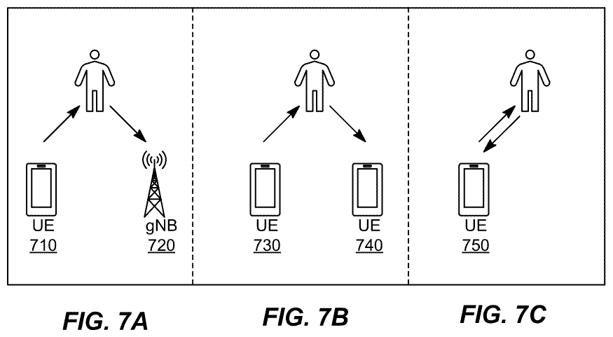

FIGS. 7A-7C illustrate example scenarios of bi-static/monostatic sensing where the dual functional signal transmits from a device. In the setup of bi-static/monostatic sensing where the common signal transmits from device/UE, one or more of device side node(s) such as UE may generate the dual functional communication-and-sensing signal and transmit. The same device-side node (i.e., the same transmitting node such as UE) or one or more base station(s)/relay(s) or device(s) may perform sensing. These scenarios are shown in FIGS. 7A-7C. FIG. 7A and FIG. 7B show the bistatic sensing scenario where the dual function of communication-and-sensing signal is received by a network-side node such as base station/relay (gNB 720) and a device (UE 740) respectively. The received signal may be used or intended to be used for sensing functions. The signal reception by the receivers that intends to decode data (receiver for communication function) can be done by the same node performing sensing or by other nodes in the system such as one or more of base station(s)/relay(s) and/or device(s). FIG. 7C shows the monostatic sensing scenario where the same device-side node such as UE 750 performs the transmission and sensing functions. These scenarios can be for uplink transmission (device side node transmission to a network side) or side link (device side node transmission to another device side).

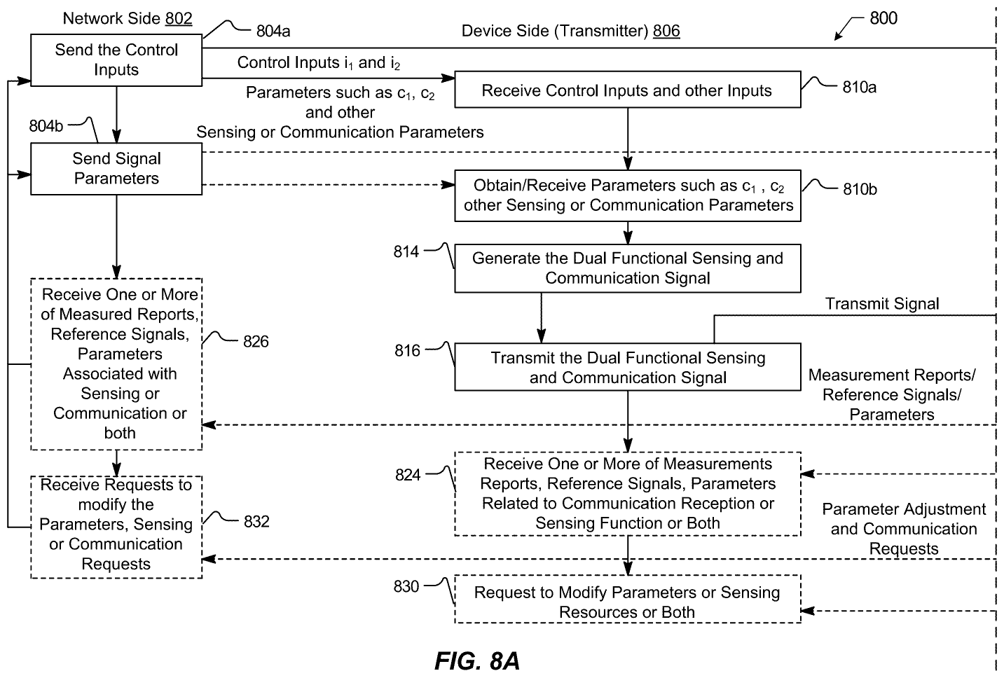

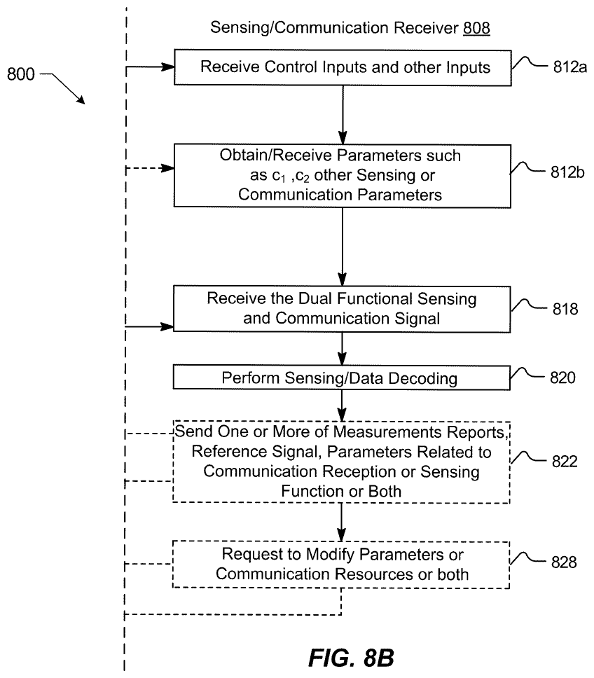

FIGS. 8A-8B illustrate an example signaling diagram 800 for bi-static/monostatic sensing where the dual functional signal transmits from device side. As described earlier, the controlled inputs i₁ and i₂ and parameters such as c₁ and c₂ can be chosen/configured/selected by the network side 802. At step 804, the selected control input values and parameters may be sent to both transmitter side 806 and the receiver(s) 808 performing sensing function and to the receiver(s) 808 performing the communication signal decoding. At step 810, transmitting node 806 may receive one or more of the controlled inputs and parameters over a signaling channel such as RRC, MAC-CE, DCI, etc. At step 812, sensing functional node 808 may receive one or more of the controlled inputs and parameters. Alternatively, one or more of the sensing functional nodes 808 may receive the controlled inputs and parameters by blindly decoding them by the receiver sides. Alternatively, one or more of the sensing functional nodes 808 may obtain the controlled inputs and parameters by an implicit manner. As an example and not by way of limitation, given a certain mode of operation, other communication/sensing requirement/configuration, etc. can help obtain the parameter values and control inputs. Signal transmitter 806, sensing receiver 808, and communication receiver 808 may receive the same control inputs and parameters or different control inputs and parameters. As an example and not by way of limitation, transmitter device 806 may require all control inputs and parameters while communication receiver 808 or sensing receiver 808 may only require a sub-set of control inputs or parameters.

Once the transmitter 806 and receiver sides 808 are aware of the control inputs and parameters, the transmitter side 806 may generate the dual functional sensing-and-communication signal based on the agreed parameters at step 814. At step 816, the transmitter side 806 may transmit the signal. The signal may be received by the sensing receiver 808 as well as the communication receiver 808 at step 818. The sensing receiver 808 and communication receiver 808 may also be within the same node, for example, as two separate modules. Alternatively, the sensing receiver 808 and communication receiver 808 may be two difference nodes. At step 820, the sensing receiver 808 may perform sensing from the received signal. Sensing may include estimating one or more of the parameters from the propagated signal such as Doppler shift, angle of arrival, angle of departure, propagation delay, pathloss, power delay profile, number of paths, line of sight, non-line of sight, etc. The communication receiver 808 may perform data decoding from the received signal at step 820.

After receiving the dual functional sensing-and-communication signal, one or both of the receivers or modules may perform certain measurements (optional). Such measurements may be reported back to the transmitter side 806. Such measurement may also trigger other actions such as transmitting configured reference signal back to the transmitter side/network side. At step 822, the sensing/communication receiver 808 may send one or more of measurements reports, reference signal, parameters related to communication reception or sensing function or both to the transmitter side 806 or network side 802. These measurements may be related to sensing function or communication function or both. One such sensing measurement may be the radar distortion. One such measurement for communication may be the received signal-to-interference-plus-noise (SINR) ratio. At step 824, the transmitter side 806 may receive one or more of measurements reports, reference signals, parameters related to communication reception or sensing function or both. At step 826, the network side 802 may receive one or more of measurements reports, reference signals, parameters related to communication reception or sensing function or both.

At step 828, sensing receiver 808 or communication receiver 808 or both may also request the transmitter side to adjust/modify/update the signal parameters or report the most suitable control inputs/parameters. At step 830, the transmitter side 806 may receive the request for modification. At step 832, the network side 802 may receive the request for modification. Sensing receiver 808 or communication receiver 808 or both may also request further transmissions (dual functional or single functional) to perform further communication or sensing. As an example and not by way of limitation, after data decoding failure, communication receiver 808 or network side 802 may request a re-transmission or schedule another transmission. Such request may be sent to the transmitter side 806 along with new parameters or configurations or control inputs or otherwise. In another example, after sensing failure (i.e., sensing does not meet the target KPI such as accuracy, resolution, range estimate or other parameter estimation performance target), the sensing receiver 808 may request a re-transmission to perform further sensing. Such request may be sent to the transmitter side 806 along with new parameters or configurations or control inputs or otherwise.

After receiving the measurement reports, reference signals, parameter updates, communication/sensing requests from sensing receiver 808 or communication receiver 808 or both, the transmitter side 806 or network side 802 or both may determine the changes or modifications to the existing transmission parameters and control inputs. These control inputs and/or parameters determined at the network side 802 may be communicated to the transmitter side 806. It should be noted that although sensing and communication receiver is represented by the same functional blocks in FIG. 8, they can be different physical devices having independent functional blocks of their own.

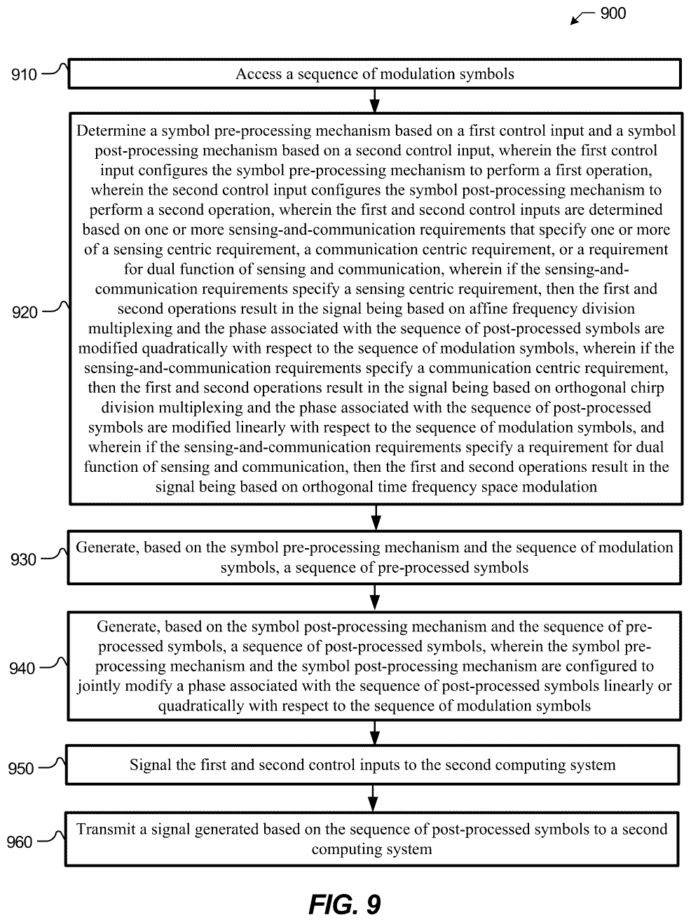

FIG. 9 illustrates is a flow diagram of a method 900 for generating a signal that can be used for both communication and sensing functions, in accordance with the presently disclosed embodiments. The method 900 may be performed utilizing one or more processing devices (e.g., a first computing system) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing wireless communication data, software (e.g., instructions running/executing on one or more processors), firmware (e.g., microcode), or some combination thereof.

The method 900 may begin at step 910 with the one or more processing devices (e.g., the first computing system). For example, in particular embodiments, the first computing system may access a sequence of modulation symbols. The method 900 may then continue at step 920 with the one or more processing devices (e.g., the first computing system). For example, in particular embodiments, the first computing system may determine a symbol pre-processing mechanism based on a first control input and a symbol post-processing mechanism based on a second control input, wherein the first control input configures the symbol pre-processing mechanism to perform a first operation, wherein the second control input configures the symbol post-processing mechanism to perform a second operation, wherein the first and second control inputs are determined based on one or more sensing-and-communication requirements that specify one or more of a sensing centric requirement, a communication centric requirement, or a requirement for dual function of sensing and communication, wherein if the sensing-and-communication requirements specify a sensing centric requirement, then the first and second operations result in the signal being based on affine frequency division multiplexing and the phase associated with the sequence of post-processed symbols are modified quadratically with respect to the sequence of modulation symbols, wherein if the sensing-and-communication requirements specify a communication centric requirement, then the first and second operations result in the signal being based on orthogonal chirp division multiplexing and the phase associated with the sequence of post-processed symbols are modified linearly with respect to the sequence of modulation symbols, and wherein if the sensing-and-communication requirements specify a requirement for dual function of sensing and communication, then the first and second operations result in the signal being based on orthogonal time frequency space modulation. The method 900 may then continue at step 930 with the one or more processing devices (e.g., the first computing system). For example, in particular embodiments, the first computing system may generate, based on the symbol pre-processing mechanism and the sequence of modulation symbols, a sequence of pre-processed symbols. The method 900 may then continue at step 940 with the one or more processing devices (e.g., the first computing system). For example, in particular embodiments, the first computing system may generate, based on the symbol post-processing mechanism and the sequence of pre-processed symbols, a sequence of post-processed symbols, wherein the symbol pre-processing mechanism and the symbol post-processing mechanism are configured to jointly modify a phase associated with the sequence of post-processed symbols linearly or quadratically with respect to the sequence of modulation symbols. The method 900 may then continue at step 950 with the one or more processing devices (e.g., the first computing system). For example, in particular embodiments, the first computing system may signal the first and second control inputs to the second computing system. The method 900 may then continue at step 960 with the one or more processing devices (e.g., the first computing system). For example, in particular embodiments, the first computing system may transmit a signal generated based on the sequence of post-processed symbols to a second computing system. Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for determining sensing and communication precoders including the particular steps of the method of FIG. 9, this disclosure contemplates any suitable method for determining sensing and communication precoders including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

### Systems and Methods

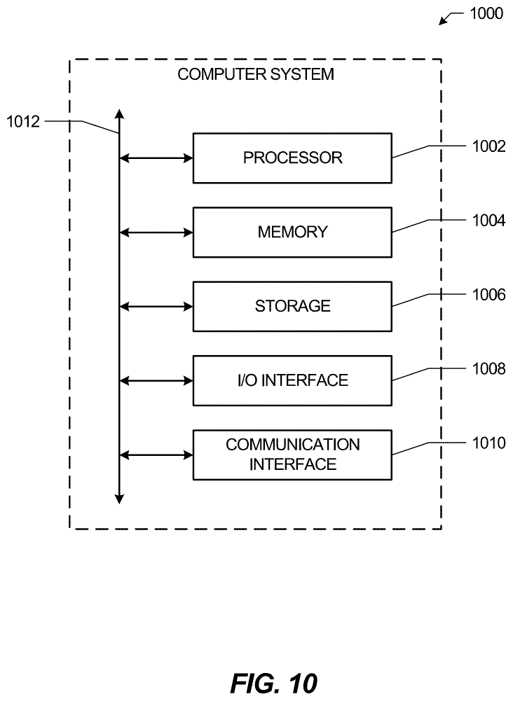

FIG. 10 illustrates an example computer system 1000 that may be utilized for determining sensing and communication precoders, in accordance with the presently disclosed embodiments. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (e.g., a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks.

Where appropriate, one or more computer systems 1000 may perform without substantial spatial or temporal limitation one or more steps of one or more methods described or illustrated herein. As an example, and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement. In particular embodiments, processor 1002 includes hardware for executing instructions, such as those making up a computer program. As an example, and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example, and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002.

Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example, and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere).

One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memory devices, where appropriate. Although this disclosure describes and illustrates particular memory, this disclosure contemplates any suitable memory.

In particular embodiments, storage 1006 includes mass storage for data or instructions. As an example, and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it.

As an example, and not by way of limitation, computer system 1000 may communicate with an ad hoc network, a personal area network (PAN), a local area network (LAN), a wide area network (WAN), a metropolitan area network (MAN), an ultra-wideband network (UWB), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example, and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

### MISCELLANEOUS

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Herein, “automatically” and its derivatives means “without human intervention,” unless expressly indicated otherwise or indicated otherwise by context.

The embodiments disclosed herein are only examples, and the scope of this disclosure is not limited to them. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a first computing system:
accessing a sequence of modulation symbols;
determining a symbol pre-processing mechanism based on a first control input and a symbol post-processing mechanism based on a second control input, wherein the first and second control inputs are determined based on one or more sensing-and-communication requirements, and wherein the one or more sensing-and-communication requirements specify one or more of a sensing centric requirement, a communication centric requirement, or a requirement for dual function of sensing and communication;
generating, based on the symbol pre-processing mechanism and the sequence of modulation symbols, a sequence of pre-processed symbols;
generating, based on the symbol post-processing mechanism and the sequence of pre-processed symbols, a sequence of post-processed symbols, wherein the symbol pre-processing mechanism and the symbol post-processing mechanism are configured to jointly modify a phase associated with the sequence of post-processed symbols linearly or quadratically with respect to the sequence of modulation symbols; and
transmitting a signal generated based on the sequence of post-processed symbols to a second computing system.

2. The method of claim 1, wherein the one or more sensing-and-communication requirements specify a sensing centric requirement, wherein the first control input configures the symbol pre-processing mechanism to perform a first operation, wherein the second control input configures the symbol post-processing mechanism to perform a second operation, and wherein the first and second operations result in the signal being based on affine frequency division multiplexing.

3. The method of claim 2, wherein the phase associated with the sequence of post-processed symbols are modified quadratically with respect to the sequence of modulation symbols.

4. The method of claim 1, wherein the one or more sensing-and-communication requirements specify a communication centric requirement, wherein the first control input configures the symbol pre-processing mechanism to perform a first operation, wherein the second control input configures the symbol post-processing mechanism to perform a second operation, and wherein the first and second operations result in the signal being based on orthogonal chirp division multiplexing.

5. The method of claim 4, wherein the phase associated with the sequence of post-processed symbols are modified linearly with respect to the sequence of modulation symbols.

6. The method of claim 1, wherein the one or more sensing-and-communication requirements specify a requirement for dual function of sensing and communication, wherein the first control input configures the symbol pre-processing mechanism to perform a first operation, wherein the second control input configures the symbol post-processing mechanism to perform a second operation, and wherein the first and second operations result in the signal being based on orthogonal time frequency space modulation.

7. The method of claim 1, further comprising:
generating, based on the sequence of modulation symbols, a matrix of symbols.

8. The method of claim 1, further comprising:
signaling, by the first computing system, the first and second control inputs to the second computing system.

9. A first computing system comprising:
one or more non-transitory computer-readable storage media including instructions; and
one or more processors coupled to the storage media, the one or more processors configured to execute the instructions to:
access a sequence of modulation symbols;
determine a symbol pre-processing mechanism based on a first control input and a symbol post-processing mechanism based on a second control input, wherein the first and second control inputs are determined based on one or more sensing-and-communication requirements, and wherein the one or more sensing-and-communication requirements specify one or more of a sensing centric requirement, a communication centric requirement, or a requirement for dual function of sensing and communication;
generate, based on the symbol pre-processing mechanism and the sequence of modulation symbols, a sequence of pre-processed symbols;
generate, based on the symbol post-processing mechanism and the sequence of pre-processed symbols, a sequence of post-processed symbols, wherein the symbol pre-processing mechanism and the symbol post-processing mechanism are configured to jointly modify a phase associated with sequence of post-processed symbols linearly or quadratically with respect to the sequence of modulation symbols; and
transmit a signal generated based on the sequence of post-processed symbols to a second computing system.

10. The first computing system of claim 9, wherein the one or more sensing-and-communication requirements specify a sensing centric requirement, wherein the first control input configures the symbol pre-processing mechanism to perform a first operation, wherein the second control input configures the symbol post-processing mechanism to perform a second operation, and wherein the first and second operations results in the signal being based on affine frequency division multiplexing.

11. The first computing system of claim 10, wherein the phase associated with the sequence of post-processed symbols are modified quadratically with respect to the sequence of modulation symbols.

12. The first computing system of claim 9, wherein the one or more sensing-and-communication requirements specify a communication centric requirement, wherein the first control input configures the symbol pre-processing mechanism to perform a first operation, wherein the second control input configures the symbol post-processing mechanism to perform a second operation, and wherein the first and second operations results in the signal being based on orthogonal chirp division multiplexing.

13. The first computing system of claim 12, wherein the phase associated with the sequence of post-processed symbols are modified linearly with respect to the sequence of modulation symbols.

14. The first computing system of claim 9, wherein the one or more sensing-and-communication requirements specify a requirement for dual function of sensing and communication, wherein the first control input configures the symbol pre-processing mechanism to perform a first operation, wherein the second control input configures the symbol post-processing mechanism to perform a second operation, and wherein the first and second operations results in the signal being based on orthogonal time frequency space modulation.

15. A computer-readable non-transitory storage media comprising instructions executable by a processor associated with a first computing system to:
access a sequence of modulation symbols;
determine a symbol pre-processing mechanism based on a first control input and a symbol post-processing mechanism based on a second control input, wherein the first and second control inputs are determined based on one or more sensing-and-communication requirements, and wherein the one or more sensing-and-communication requirements specify one or more of a sensing centric requirement, a communication centric requirement, or a requirement for dual function of sensing and communication;
generate, based on the symbol pre-processing mechanism and the sequence of modulation symbols, a sequence of pre-processed symbols;
generate, based on the symbol post-processing mechanism and the sequence of pre-processed symbols, a sequence of post-processed symbols, wherein the symbol pre-processing mechanism and the symbol post-processing mechanism are configured to jointly modify a phase associated with sequence of post-processed symbols linearly or quadratically with respect to the sequence of modulation symbols; and
transmit a signal generated based on the sequence of post-processed symbols to a second computing system.

16. The media of claim 15, wherein the one or more sensing-and-communication requirements specify a sensing centric requirement, wherein the first control input configures the symbol pre-processing mechanism to perform a first operation, wherein the second control input configures the symbol post-processing mechanism to perform a second operation, and wherein the first and second operations results in the signal being based on affine frequency division multiplexing.

17. The media of claim 16, wherein the phase associated with the sequence of post-processed symbols are modified quadratically with respect to the sequence of modulation symbols.

18. The media of claim 15, wherein the one or more sensing-and-communication requirements specify a communication centric requirement, wherein the first control input configures the symbol pre-processing mechanism to perform a first operation, wherein the second control input configures the symbol post-processing mechanism to perform a second operation, and wherein the first and second operations results in the signal being based on orthogonal chirp division multiplexing.

19. The media of claim 18, wherein the phase associated with the sequence of post-processed symbols are modified linearly with respect to the sequence of modulation symbols.

20. The media of claim 15, wherein the one or more sensing-and-communication requirements specify a requirement for dual function of sensing and communication, wherein the first control input configures the symbol pre-processing mechanism to perform a first operation, wherein the second control input configures the symbol post-processing mechanism to perform a second operation, and wherein the first and second operations results in the signal being based on orthogonal time frequency space modulation.
